(19) United States
(12) Patent Application Publication
(10) Pub. No.: US 2019/0095764 A1
(43) Pub. Date: Mar. 28, 2019

(54) METHOD AND SYSTEM FOR DETERMINING OBJECTS DEPICTED IN IMAGES

(71) Applicant: PANTON, INC., Houston, TX (US)

(72) Inventor: Saishi Frank LI, Sugar Land, TX (US)

(21) Appl. No.: 16/143,004

(22) Filed: Sep. 26, 2018

Related U.S. Application Data
(60) Provisional application No. 62/563,482, filed on Sep. 26, 2017.

(51) Int. Cl. G06K 9/66; G06N 3/08; G06K 9/62; G06K 9/40; G06K 9/44; G06K 9/00

(52) U.S. Cl. CPC G06K 9/66; G06N 3/08; G06K 9/6256; G06K 9/40; G06F 17/30256; G06K 9/627; G06K 9/6284; G06K 9/00637; G06K 9/44

(57) ABSTRACT

Techniques are disclosed for identifying objects in images. In one embodiment, transfer learning is employed to build new classifiers on top of pre-trained machine learning models, such as pre-trained convolutional neural networks (CNNs), by re-training classification layers of the pre-trained machine learning models using new training data while keeping feature detection layers of the pre-trained machine learning models fixed. Subsequently, the re-trained machine learning models may take as input images depicting regions of interest extracted from larger images using a sliding window, a saliency map, an image disparity map, and/or a region of interest detection technique, and output classifications of objects in the input images. In addition, a meta model may be learned that aggregates outputs of the re-trained machine learning models for robustness.

### CROSS-REFERENCE TO RELATED APPLICATIONS

This application claims priority to U.S. provisional application having Ser. No. 62/563,482, filed on Sep. 26, 2017, which is hereby incorporated by reference in its entirety.

### BACKGROUND

### Field of the Invention

The present invention relates generally to computer image processing and, in particular, to determining objects in images.

### Description of the Related Art

Machine learning techniques, such as those utilizing convolutional neural networks (CNNs), have been applied to analyze visual imagery. However, traditional machine learning models may require very large data sets to train, such as millions of training images. In addition, traditional machine learning models have not been optimized for identifying, and determining the locations of, relatively small objects that are depicted in larger images, such as wind or hail damage that appear in images of a building's roof.

### SUMMARY

One embodiment provides a method for identifying objects in images. The method generally includes re-training one or more classification layers of one or more previously trained machine learning models. The method further includes extracting, from a received image, one or more images depicting regions of interest in the received image. In addition, the method includes determining objects that appear in the one or more extracted images using, at least in part, the one or more previously trained machine learning models with the one or more re-trained classification layers.

Further embodiments provide a non-transitory computer-readable medium that includes instructions that, when executed, enable a computer to implement one or more aspects of the above method, and a computer system programmed to implement one or more aspects of the above method.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an approach for training a machine learning model which includes multiple classifiers and a meta model, according to an embodiment.

FIG. 2 illustrates an approach for training a classifier in a pre-trained machine learning model, according to an embodiment.

FIG. 3 illustrates a method for training a machine learning model, according to an embodiment.

FIG. 4 illustrates a method for determining objects that appear in an image, according to an embodiment.

FIG. 5 illustrates an example of an image that may be received in the case of damage detection, according to an embodiment.

FIG. 6 illustrates a system in which an embodiment of this disclosure may be implemented.

### DETAILED DESCRIPTION OF EXEMPLARY EMBODIMENTS

Embodiments of the disclosure presented herein provide techniques for determining objects that appear in images. Property damage is used herein as an example of object(s) that may be determined, but it should be understood that techniques disclosed herein are also applicable to determining other types of objects. The determining of property damage (or other object(s)) may include classification of an image as including property damage (or other object(s)) or not and/or detecting the particular type(s) of property damage (or other object(s)) that appear in an image. Further, techniques disclosed herein may be used to determine objects appearing in images captured individually, as well as images that are frames of a video. In one embodiment, transfer learning is employed to build new classifiers on top of pre-trained machine learning models, such as pre-trained convolutional neural networks (CNNs), by re-training classification layers of the pre-trained machine learning models using new training data while keeping feature detection layers of the pre-trained models fixed. In an alternative embodiment, the assumption of fixed feature detection layers may be relaxed, and the transfer learning may also re-train the feature detection layers of pre-trained machine learning models. Subsequent to the transfer learning, the re-trained machine learning models (i.e., the machine learning models whose classification layers and/or feature detection layers have been re-trained) may take as input images depicting regions of interest extracted from larger images (e.g., using a sliding window, a saliency map, and/or a region of interest detection technique) and output classifications of objects (or the lack thereof) in the input images. In addition, a meta model may be learned that aggregates outputs of the re-trained machine learning models for robustness.

Herein, reference is made to embodiments of the invention. However, it should be understood that the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications (e.g., an object detection application) or related data available in the cloud. For example, an object detection application could execute on a computing system in the cloud and process images and/or videos to determine objects that appear in those images and/or videos, as disclosed herein. Doing so allows a user to access this information from any computing system attached to a network connected to the cloud (e.g., the Internet).

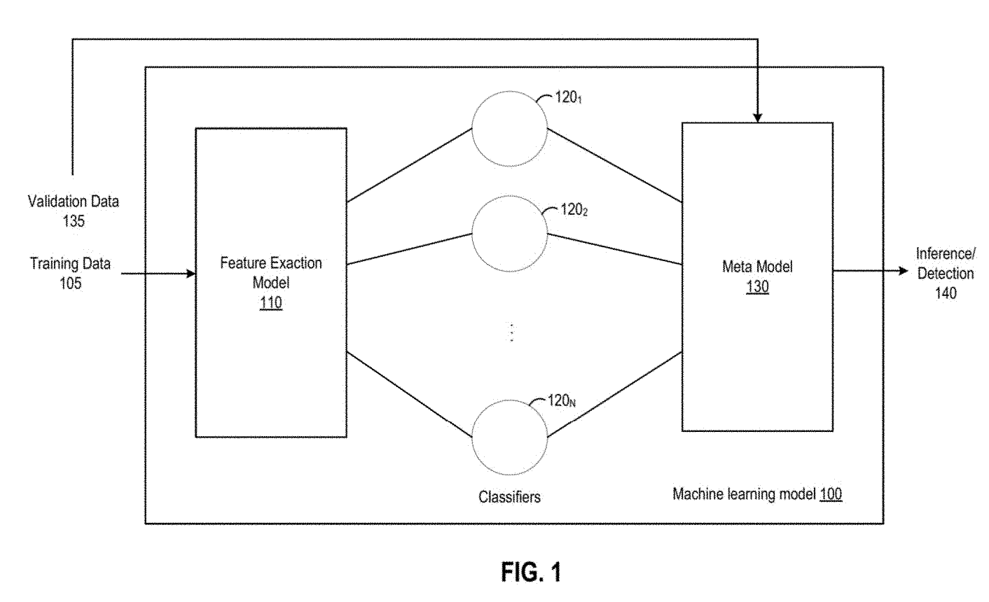

Referring now to FIG. 1, a diagram is shown illustrating an approach for training a machine learning model 100 that includes a feature extraction model 110, an ensemble of classifiers 120_{1-N}, and a meta model 130, according to an embodiment. Illustratively, training data 105 is used during such training. In one embodiment, the training data 105 may include set(s) of images that include objects to be determined as positive training set(s) and other set(s) of images that do not include such objects as negative training set(s), as well as corresponding labels (of the objects or lack thereof). In the case of damage detection, the objects to be determined may include various types of property damage, and the training data 105 may include image set(s) that depict respective types of property damage and other image set(s) depicting properties with no property damage and/or image set(s) depicting property damage in general and other image set(s) depicting properties with no property damage. The images themselves that are used in training (and later in determining property damage using a trained model) may be captured in any feasible manner, such as using unmanned aerial vehicles (UAVs), handheld computing devices (e.g., mobile phone or tablets), stationary cameras, satellites, helicopters, and the like. In some embodiments, pre-processing (not shown) may also be performed to, e.g., convert such images to grayscale and denoise the images.

For example, to train the machine learning model 100 to determine damage to the roofs of buildings, training data may be used that includes images depicting roofs that have suffered various types of damage, such as wind damage, hail damage, damage due to age and wear, etc. as positive training sets, as well as images depicting roofs without damage as a negative training set. In one embodiment, the training images may include image regions that are either manually extracted from larger images depicting wider areas of roofs, such as images depicting entire roofs, or the image regions may be automatically extracted from larger images, e.g., based on user input. In one embodiment, a user may click on an object (e.g., a damage) location, and one or more images depicting region(s) around the clicked location may be automatically extracted based on the clicked location. For example, the extracted images may depict regions having the clicked location at their centers and/or away from their centers, and the extracted images may also be rotated so that the overall detection system is invariant to objects' rotation and translation. As another example, the user input may include manually extracted image regions with objects at or near the centers of the regions, as well as associated tags specifying the types of objects that appear in those regions, and the manually extracted regions may be shifted (e.g., to the left, right, up, and down) and/or rotated to generate additional training images. This process of expanding the training set from a given limited set of (manual) human tagged data to an expanded set of tagged data may improve the machine learning model's predictive capabilities. Also, automatically generating rotated and shifted samples can decrease the cost and time expended, by reducing human interaction (tagging) time.

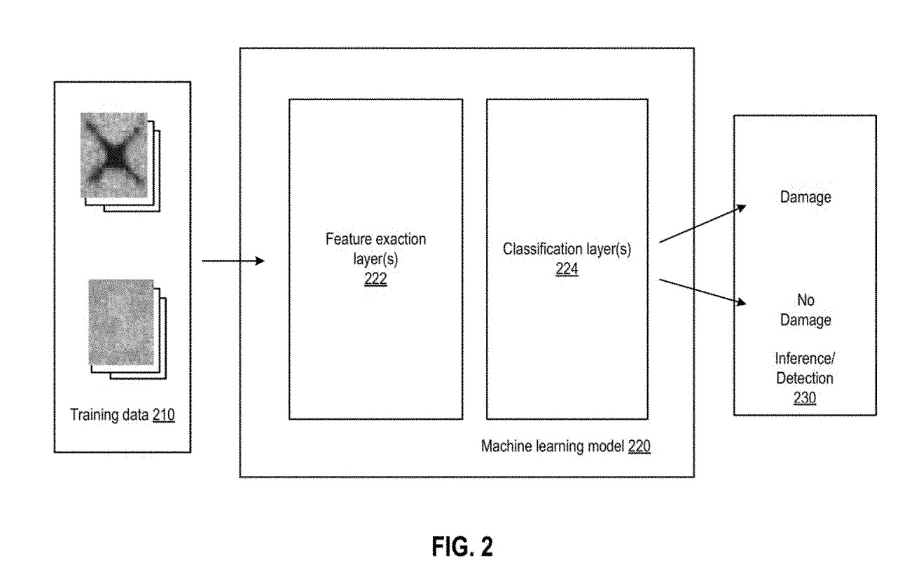

The feature extraction model 110 is responsible for extracting features including the geometric properties of objects in received images, such as the line, ellipsoid, etc. shapes of those objects. Although one feature extraction model 110 is shown for simplicity, it should be understood that the feature extraction model 110 may also include the feature extraction layers of more than one machine learning model in an ensemble form. For example, the feature extraction model 110 may include the feature extraction layers from a number of pre-trained CNNs whose parameters are fixed (or, alternatively, each fine-tuned separately with the same training data or with different training data), while the classification layers of those CNNs are trained using the training data 105, as described in greater detail below with respect to FIG. 2. It is assumed herein that the pre-trained CNNs have been trained using large data sets, such as the ImageNet data set, and as a result the pre-trained CNNs' feature extraction layers are able to extract relevant features from images. It has been shown that well-trained CNNs are able to extract features similar to those a human brain would identify.

The classifiers 120_{1-N} of the ensemble of classifiers, which are also sometimes referred to as members of the ensemble, are trained to identify whether objects are present in an image or not based on features extracted by the feature extraction model 110. In one embodiment, the classifiers 120_{1-N} may include the classification layers of pre-trained CNNs, and transfer learning may be employed to train such classification layers using the training data 105. In such a case, weight parameters of the classification layers are re-trained using the training data 105 so that the classification layers are better suited to identifying particular objects depicted in the training data 105. For example, in the case of damage detection, the classification layers may be re-trained using image set(s) depicting property damage (and/or specific types of property damage) and other image set(s) depicting properties without damage. The re-trained classification layers would then be able to distinguish between damaged and not damaged (and/or specific types of damage to) property depicted in input images. It should be understood that the classification layers (classifiers) in each pre-trained CNN may be re-trained using all of the available training data or, alternatively, each of the classifiers may be trained using a randomly selected (with replacement) subset of the available training data. Alternatively, each member of the ensemble of classifiers may be trained using a subset of the training data as well as a subset of corresponding features output by feature extraction layers. That is, random training data subsampling and/or random feature set subsampling may be employed.

The meta model 130 is trained to be able to determine how well each of the classifiers 120_{1-N} is expected to perform in determining desired objects in an input image. It should be understood pre-trained CNNs that are re-trained through transfer learning may have different architectures and/or network weight values, and such re-trained CNNs may perform differently in determining objects that appear in different types of images (e.g., some may produce fewer false positives while others may be able to determine a larger percentage of objects that appear in the images). Pre-trained CNNs may also have identical architectures, but the classifiers 120_{1-N} that are re-trained through transfer learning may not be identical. Such classifiers 120_{1-N} that are not identical may perform differently in determining objects that appear in different types of images. In one embodiment, the meta model 130 outputs, for each classifier of the ensemble of classifiers 120_{1-N}, a respective score/confidence value indicating how well that classifier is expected to perform in determining objects that appear in an input image. That is, the meta model 130 takes as input an image and determines scores/confidence values for the classifiers 120_{1-N} that may in turn be used to aggregate the classifications output by the ensemble of classifiers 120_{1-N} into a final classification value (e.g., using a weighted average or a voting scheme). Illustratively, the meta model 130 is trained using validation data 135 and, based on such validation data 135, it is learned how the classifiers 120_{1-N} perform under various circumstances, such as when determining different types of property damage (e.g., hail damage, wind damage, damage due to age and wear, etc.) and/or when determining damage to different types of properties (e.g., damage to lighter colored roof shingles as opposed to darker colored shingles). The validation data 135 may include some images with their correct classification labels, which are similar to the training set 105 but are not originally included in training any of the other classifiers 120_{1-N}. As a result, the trained meta model 130 is capable of determining scores/confidence values that may be used (e.g., in a simple weighted average or voting scheme) to aggregate the classifications made by the classifiers 120_{1-N}. Such an aggregation is used to learn how each classifier performs for each type of image and apply that to assign a final label to the image, producing the output inference/detection 140. This step is in fact another classification step, and either a linear model (e.g., a weighted average of each of the classifiers 120_{1-N}) or a more complex model such as a neural network that provides a score for each classifier, a random forest that provides a score as well as a measure of uncertainty (e.g., confidence values), a linear weighted least squares aggregation, or the like may be used as the meta model 130.

FIG. 2 illustrates an approach for (re-)training a classifier 224 of a pre-trained machine learning model 220, according to an embodiment. In one embodiment, the classifier 224 may be one of the classifiers 120_{1-N} in the ensemble of classifiers described above with respect to FIG. 1. As shown, the pre-trained machine learning model 220 includes feature extraction layer(s) 222 and classification layer(s) 224. As described, the feature extraction layer(s) 222 may extract features including geometric properties of objects in received images, and in turn the classification layer(s) 224 may take the extracted features as input and output classifications of objects present in the images. In one embodiment, the machine learning model 220 may be a CNN, in which case the feature extraction layer(s) 222 may include convolution and pooling layers, and the classification layer(s) 224 may include fully connected layer(s).

In one embodiment, transfer learning is used to re-train weight parameters in the classification layer(s) 224, while weight parameters in the feature extraction layer(s) 222 are fixed. For example, a gradient descent or stochastic gradient descent algorithm may be used to minimize a loss function during such re-training of the classification layer(s) 224 weights. It should be understood that gradient descent and stochastic gradient descent algorithms are optimization functions that may be used to find network weights that converge to a minimum of a loss function, with the stochastic gradient descent algorithm allowing larger changes to the weights to avoid being trapped in local minima. As described, the feature extraction layers may be fixed in one embodiment, under the assumption that the pre-trained machine learning model 220 was trained using a large data set and is already able to extract relevant features from images.

Re-training the weight parameters in the classification layer(s) 224 may improve the machine learning model's 220 performance in identifying particular objects of interest. Returning to the example of damage detection, the training data in one embodiment may include set(s) of images that depict property damage as positive training set(s) and other set(s) of images that depict (regions of) propert(ies) that are not damaged as negative training set(s), as well as corresponding labels. As shown, the training data 210 includes a set of images 212 depicting property damage that are extracted (either manually or automatically extracted based on user input) from larger images of properties, as well as extracted images 214 that depict regions of properties that are not damaged. Such training data may be used to train the classifier 224 to distinguish between damaged regions and undamaged regions in an input image and output classifications/detections 230 of the same. In addition, the training data may include image sets depicting different types of property damage, such as wind damage, hail damage, damage due to age and wear, etc. as positive training sets, and corresponding labels specifying the appropriate type of property damage, as well as image set(s) depicting property without damage as negative training set(s), which may be used to train the classifier 224 to distinguish between the different types of property damage. In one embodiment, different (or the same) machine learning models may be re-trained to first classify input images as including property damage or not and then determine the specific type of property damage, respectively.

Although the feature extraction layer(s) 222 are shown as being fixed, this assumption may be relaxed in an alternative embodiment. In such a case, weight parameters in the feature extraction layer(s) 222 may be trained along with weight parameters of the classification layer(s) 224 using, e.g., the expanded set of data discussed above. Doing so may improve the ability of the feature extraction layer(s) 222 to extract features relevant to the identification of objects of interest, such as property damage. In another embodiment, the training images 212 and 214, as well as the images taken as input during the inference phase (after training is completed), may first be pre-processed by, e.g., converting the images to grayscale so as to reduce the effects of different lighting conditions under which images may be captured.

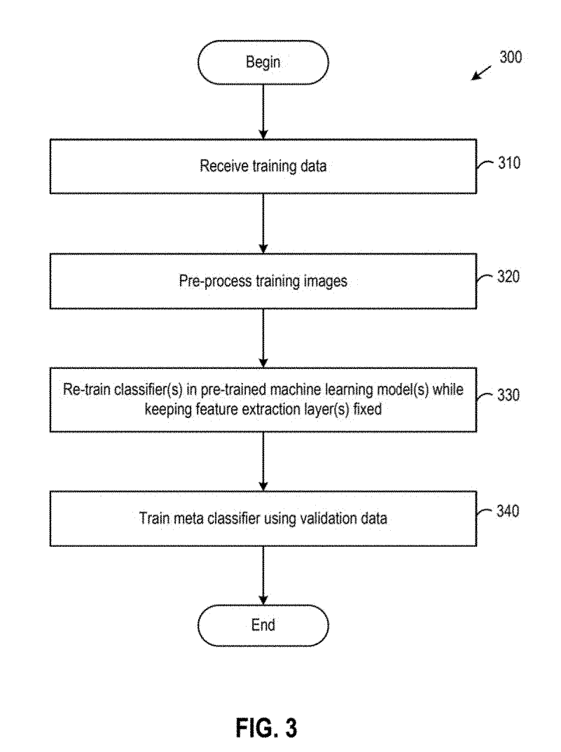

FIG. 3 illustrates a method 300 for training a machine learning model, according to an embodiment. As shown, the method 300 begins at step 310, where the detection application receives training data. In the case of damage detection, such training data may include set(s) of images that depict property damage, and/or distinct types of property damage, and set(s) of images that depict properties without damage, as well as corresponding labels. As described, the set(s) of training images may be extracted from larger images, either manually or automatically based on some user input. For example, a number of training images may be automatically extracted based on a user click on an object location, with images region(s) around the clicked location (with the clicked location at their centers and/or away from their centers) being extracted and also rotated for rotational invariance. As another example, the set(s) of training images may include manually extracted images depicting regions that include objects at or near their centers, as well as associated tags, and such manually extracted images may be shifted (e.g., to the left, right, up, and down) and/or rotated to generate additional training images.

At step 320, the detection application pre-processes the training images. In one embodiment, such pre-processing may include converting the training images to grayscale using a robust grayscale conversion algorithm and denoising the images. Other types of pre-processing that may improve detection performance are also contemplated. For example, when attempting to determine damage to roofs, images depicting the roofs may be pre-processed to remove straight lines corresponding to shingles on the roofs, as such lines are not indicative of damage to the roofs.

At step 330, the detection application re-trains the classifier(s) in pre-trained machine learning model(s), while keeping feature extraction layer(s) of the pre-trained model(s) fixed. In one embodiment, the pre-trained model(s) may be members of an ensemble of classifiers, and the pre-trained model(s) may further include CNNs that were trained using one or more large image sets. In such a case, the training at step 330 may use smaller set(s) of training images depicting objects of interest (or particular types of objects) as positive training set(s), as well set(s) of images depicting no such objects of interest as negative training set(s), to re-train classification layers of the pre-trained CNNs. In addition, the feature extraction layers of the CNNs may be fixed during such re-training of the classification layers in one embodiment. It should be understood that this form of transfer learning allows the classification layers to be trained with fewer images than would otherwise be required to train CNNs from scratch. In an alternative embodiment, the feature extraction layer(s) of the pre-trained model(s) may also be trained along with the classification layer(s), rather than being fixed, which allows the feature extraction layer(s) to be fine-tuned for the particular object detection task. Any feasible training algorithm may be employed, such as a gradient descent algorithm or stochastic gradient descent algorithm that is used to minimize a loss function.

In one embodiment, the classification layers in each pre-trained CNN may be re-trained using all available training data. In an alternative embodiment, each of the classifiers may be trained using a randomly selected (with replacement) subset of training data. In yet another embodiment, each pre-trained CNN may be re-trained using a subset of the set of training data as well as a subset of corresponding features output by feature extraction layers. That is, random training data subsampling, as well as random feature set subsampling, may be employed such that the same or a different classifier may be trained on the same or different training sets with the same or different feature sets.

At step 340, the detection application trains a meta model using validation data. In particular, the meta model may be trained to determine how the classifiers in an ensemble of classifiers (e.g., the classification layer(s) of CNNs that are re-trained) perform on various types of images. Subsequently, the trained meta model may take as input the same image input into the CNNs whose classifiers have been re-trained and output scores/confidence values for each of the classifiers that may then be used (e.g., in a weighted average or a voting scheme) to aggregate classifications made by the ensemble of classifiers. In one embodiment, the meta model may include a simple weighted average. In other embodiments, the meta model may be more sophisticated, such as a neural network that provides a score for each classifier, a random forest that provides a score as well as a measure of uncertainty, a linear weighted least squares aggregation, or the like. The validation data used to train the meta model may include, e.g., a number of images with their correct classification labels, which is similar to the data used to re-train the pre-trained models at step 330, except the images used to train the meta model may be distinct from those used to re-train the pre-trained models.

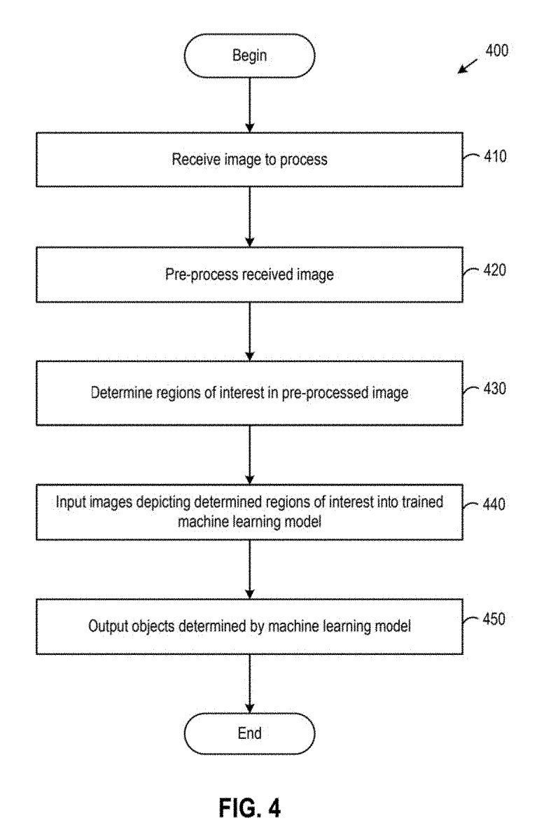

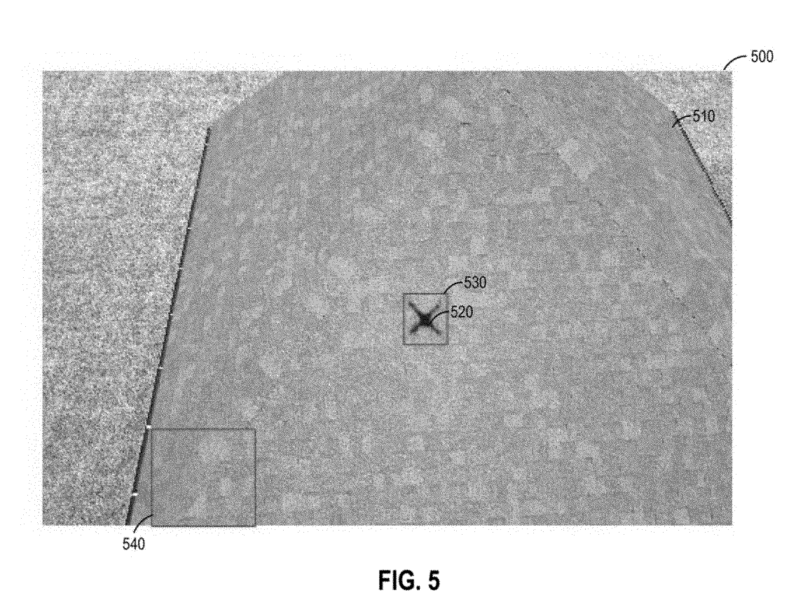

FIG. 4 illustrates a method 400 for determining objects that appear in an image, according to an embodiment. As shown, the method 400 begins at step 410, where the detection application receives an image to process. An example of an image 500 that may be received in the case of damage detection is shown in FIG. 5. Illustratively, the image 500 depicts the roof of a building with damage 520 to it. The detection application is configured to process such received images and determine objects therein, such as distinguishing between image regions including property damage (e.g., region 530) and regions that do not include property damage (e.g., region 540) and/or the particular types of property damage depicting in an image.

Returning to FIG. 4, the detection application pre-processes the received image at step 420. Similar to the pre-processing step during training of the machine learning model, the pre-processing at step 420 may include, e.g., converting the received image to grayscale, denoising, and removing lines and/or shapes that do not correspond to objects to be determined.

At step 430, the detection application determines regions of interest in the pre-processed image. It should be understood that performance of a machine learning model in determining objects that appear in images may be sensitive to the locations of those objects in the images. For example, a machine learning model trained using images depicting regions with property damage that are extracted from larger images may perform better in determining property damage that appears in the centers of input images, as opposed to images depicting damage away from their centers. To improve performance, the detection application may first extract images depicting regions of interest from the image received at step 410 and pre-processed at step 420, and then feed those extracted images to the machine learning model.

In one embodiment, the detection application may extract images from the larger, pre-processed image using a sliding window that is moved across the pre-processed image. In such a case, the detection application may either extract images that do not overlap with neighboring images that are extracted or that have some overlap with neighboring images. In another embodiment, the detection application may extract images from the pre-processed image based at least in part on a selective search, a saliency map, or an image disparity map that is used to identify regions of interest (e.g., lines or edges that may be indicative of property damage) in the pre-processed image. In yet another embodiment, the detection application may extract images by first processing the received image through the entire method 400 (e.g., using a sliding window at step 430) to identify regions that are predicted to include objects of interest, and then aggregate those results. For example, the results may be aggregated through a region of interest detection technique that eliminates redundant detections of the same objects or by building a saliency map that can be used in another pass of the method 400. It should be understood that each of these techniques for extracting images from the larger, pre-processed image has its advantages and drawbacks. For example, the sliding window approach will not miss any areas of the pre-processed image and can be used where the classifiers are not shift-invariant and to improve classification accuracy (based on multiple translations of the desired object). However, the computation time increases linearly with the sliding window approach (with the overlapping sliding window approach being more computationally expensive than the non-overlapping sliding window approach), region of interest detection may be required prior to classification, and the same object may be identified multiple times if portions of that object appear in multiple sliding windows. On the other hand, the selective search and saliency map approaches tend to be more computationally efficient but may require manual, subjective tuning of parameters.

The sizes of the regions of interest determined at step 430 may generally be the same or different. For example, in the case of damage detection, property damage that appears in images may vary in size and, in one embodiment, the detection application may determine regions of interest that also vary in size. Such regions may then be re-sized for input into a trained machine learning model. In another embodiment, the detection application may determine regions of interest that are all the same size by, e.g., using a fixed-size sliding window.

At step 440, the detection application inputs images depicting the determined regions of interest into the trained machine learning model to determine objects therein. In one embodiment, the trained machine learning model may have the structure of the machine learning model 100 discussed above with respect to FIG. 1 and be trained according to the method 300 discussed above with respect to FIG. 3. As described, such a trained machine learning model may take as input an image and output a classification, based on an aggregation of classifications made by individual classifiers, of whether the input image depicts a particular object and/or a type of object that appears in the input image. For example, in the case of damage detection, the trained machine learning model may output, for each input image depicting a region of interest, a classification of whether the image depicts property damage or not and/or a classification of a particular type of property damage. In one embodiment, different (or the same) machine learning models may be re-trained to first classify input images as including property damage or not and then detect the specific type of property damage, respectively.

At step 450, the detection application outputs objects determined by the machine learning model. For example, in the case of damage detection, the detection application may output the classifications of each region of interest as depicting property damage or not and/or the type of damage that appears in each of the regions of interest. Such an output may then be displayed to a user via a display device or utilized in any feasible manner, such as to generate a report of costs to repair the determined property damage based on, e.g., the sizes of each determined region of damage as measured from the images or a three-dimensional model generating using images, a conversion factor for converting the sizes into real-world units, and per-unit costs of materials and labor.

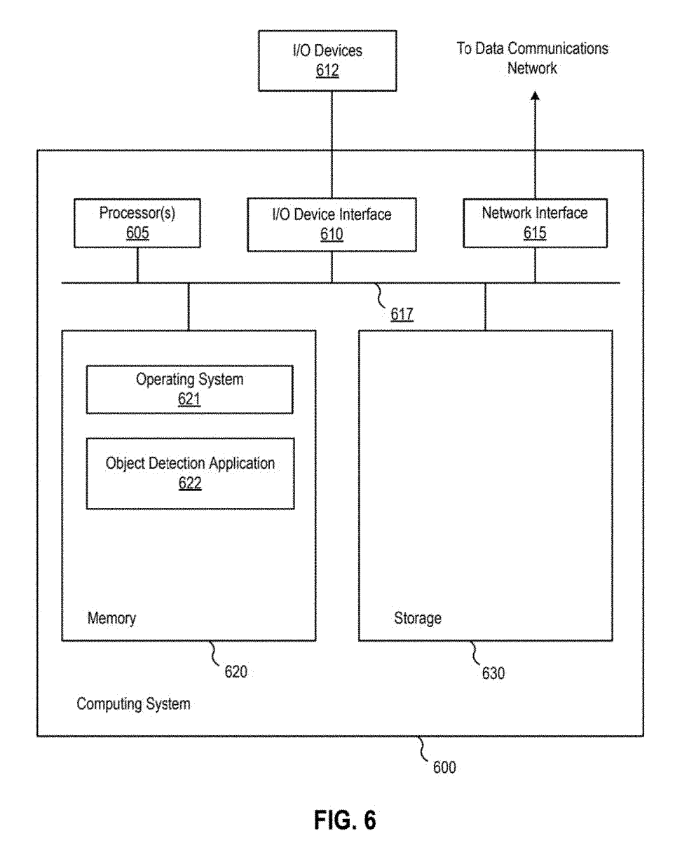

FIG. 6 illustrates a system 600 in which an embodiment of this disclosure may be implemented. As shown, the system 600 includes, without limitation, processor(s) 605, a network interface 615 connecting the system to a network, an interconnect 617, a memory 620, and storage 630. The system 600 may also include an I/O device interface 610 connecting I/O devices 612 (e.g., keyboard, display and mouse devices) to the system 600.

The processor(s) 605 generally retrieve and execute programming instructions stored in the memory 620. Similarly, the processor(s) 605 may store and retrieve application data residing in the memory 620. The interconnect 617 facilitates transmission, such as of programming instructions and application data, between the processor(s) 605, I/O device interface 610, storage 630, network interface 615, and memory 620. Processor(s) 605 is included to be representative of general purpose processor(s) and optional special purpose processors for processing video data, audio data, or other types of data. For example, processor(s) 605 may include a single central processing unit (CPU), multiple CPUs, a single CPU having multiple processing cores, one or more graphical processing units (GPUS), one or more FPGA cards, or a combination of these. And the memory 620 is generally included to be representative of a random access memory. The storage 630 may be a disk drive storage device. Although shown as a single unit, the storage 630 may be a combination of fixed or removable storage devices, such as magnetic disk drives, flash drives, removable memory cards or optical storage, network attached storage (NAS), or a storage area-network (SAN). Further, system 600 is included to be representative of a physical computing system as well as virtual machine instances hosted on a set of underlying physical computing systems. Further still, although shown as a single computing system, one of ordinary skill in the art will recognize that the components of the system 600 shown in FIG. 6 may be distributed across multiple computing systems connected by a data communications network.

As shown, the memory 620 includes an operating system 621 and an object detection application 622. The operating system 621 may be, e.g., Linux® or Microsoft Windows®. The object detection application 622 is configured to determine objects in received images using a trained machine learning model. In one embodiment, the object detection application 622 (or another application) may train the machine learning model by receiving training data, pre-processing training images, re-training classifiers in pre-trained model(s) while keeping feature extraction layer(s) of the pre-trained model(s) fixed, and training a meta model using validation data, according to the method 300 described above with respect to FIG. 3. Using the trained machine learning model, the object detection application 622 may make object detections in one embodiment by receiving an image to process, pre-processing the received image, determining regions of interest in the pre-processed image, inputting images depicting each region of interest into the trained machine learning model to determine objects therein, and outputting objects determined by the machine learning model, according to the method 400 described above with respect to FIG. 4.

Although described herein primarily with respect to images captured by photographic cameras, in other embodiments, other types of cameras may be used in lieu of or in addition to photographic cameras to capture images for training purposes and for determining objects using a trained machine learning model. For example, thermal or depth camera(s) may be used in one embodiment to capture heat or depth signatures, respectively.

Although described herein primarily with respect to an ensemble of classifiers which are CNNs, other types of classifiers may be used along with, or in lieu of, CNNs. For example, other machine learning models, image disparity maps, and/or human intelligence responses (e.g., Amazon Mechanical Turk™), etc. may be used as ensemble members.

Although described herein primarily with respect to re-training the classification layers and/or feature detection layers of previously trained machine learning models, the re-trained machine learning models (and meta models) may themselves be re-trained (e.g., periodically) using additional training data, thereby improving the accuracy of the re-trained machine learning models (and meta models). For example, additional training data may be derived from images that are received depicting property damage.

Although described herein primarily with respect to property damage, it should be understood that techniques disclosed herein are also applicable to determining other types of objects in images.

Advantageously, techniques disclosed herein provide an automated approach for determining objects that appear in images. By re-training the classification layer(s) in pre-trained models while keeping feature detection layer(s) fixed, machine learning models for object detection can be trained using a relatively small number of training images. In addition, an ensemble classifier may be trained to aggregate the output of a number of pre-trained models that have been re-trained, thereby accounting for differences in performance of the models under different circumstances. In one use case, damage may be determined in images depicting properties such as buildings or vehicles.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order or out of order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the foregoing is directed to embodiments of the present invention, other and further embodiments of the invention may be devised without departing from the basic scope thereof, and the scope thereof is determined by the claims that follow.

What is claimed is:

1. A computer-implemented method for identifying objects in images, the method comprising:
re-training one or more classification layers of one or more previously trained machine learning models;
extracting, from a received image, one or more images depicting regions of interest in the received image; and
determining objects that appear in the one or more extracted images using, at least in part, the one or more previously trained machine learning models with the one or more re-trained classification layers.

2. The method of claim 1, wherein the one or more images depicting regions of interest are extracted from the received image using at least one of a sliding window, a saliency map, an image disparity map, or a region of interest detection technique.

3. The method of claim 2, further comprising:
training another model to aggregate outputs of the one or more previously trained machine learning models with the one or more re-trained classification layers,
wherein the determining of the objects further uses the trained other model.

4. The method of claim 3, wherein the other model includes at least one of a neural network, a weighted average, or a random forest classifier.

5. The method of claim 3, wherein the saliency map is generated based on at least an output of the trained other model after objects are determined in the received image using, at least in part, the one or more previously trained machine learning models with the one or more re-trained classification layers and the trained other model.

6. The method of claim 1, further comprising, pre-processing the received image by at least one of denoising and converting the received image to grayscale or removing at least one of lines or shapes which do not correspond to objects to be determined in the received image.

7. The method of claim 1, wherein feature extraction layers of the one or more previously trained machine learning models are fixed during the re-training of the one or more classification layers of the one or more previously trained machine learning models.

8. The method of claim 1, further comprising:
extracting training images from one or more larger images based, at least in part, on user-specified locations of objects in the one or more larger images,
wherein the one or more classification layers of the one or more previously trained machine learning models are re-trained using the extracted training images.

9. The method of claim 8, wherein the extracted training images include images having centers that are at the user-specified locations, images having centers that are not at the user-specified locations, and rotations of the images having centers at the user-specified locations and not at the user-specified locations.

10. The method of claim 1, wherein the determined objects include property damage.

11. The method of claim 1, wherein:
the one or more previously trained machine learning models include one or more convolutional neural networks; and
the one or more previously trained machine learning models include machine learning models having distinct architectures.

12. A non-transitory computer-readable storage medium storing instructions that, when executed by a processor, cause a computer system to perform operations for identifying objects in images, the operations comprising:
re-training one or more classification layers of one or more previously trained machine learning models;
extracting, from a received image, one or more images depicting regions of interest in the received image; and
determining objects that appear in the one or more extracted images using, at least in part, the one or more previously trained machine learning models with the one or more re-trained classification layers.

13. The computer-readable storage medium of claim 12, wherein the one or more images depicting regions of interest are extracted from the received image using at least one of a sliding window, a saliency map, an image disparity map, or a region of interest detection technique.

14. The computer-readable storage medium of claim 13, the operations further comprising:
training another model to aggregate outputs of the one or more previously trained machine learning models with the one or more re-trained classification layers,
wherein the determining of the objects further uses the trained other model.

15. The computer-readable storage medium of claim 14, wherein the other model includes at least one of a neural network, a weighted average, or a random forest classifier.

16. The computer-readable storage medium of claim 12, the operations further comprising, pre-processing the received image by at least one of:
denoising and converting the received image to grayscale; or
removing at least one of lines or shapes which do not correspond to objects to be determined in the received image.

17. The computer-readable storage medium of claim 12, wherein feature extraction layers of the one or more previously trained machine learning models are fixed during the re-training of the one or more classification layers of the one or more previously trained machine learning models.

18. The computer-readable storage medium of claim 12, the operations further comprising:
extracting training images from one or more larger images based, at least in part, on user-specified locations of objects in the one or more larger images,
wherein the one or more classification layers of the one or more previously trained machine learning models are re-trained using the extracted training images.

19. The computer-readable storage medium of claim 18, wherein the extracted training images include images having centers that are at the user-specified locations, images having centers that are not at the user-specified locations, and rotations of the images having centers at the user-specified locations and not at the user-specified locations.

20. A system, comprising:
a processor; and
a memory wherein the memory includes an application program configured to perform operations for identifying objects in images, the operations comprising:
re-training one or more classification layers of one or more previously trained machine learning models,
extracting, from a received image, one or more images depicting regions of interest in the received image, and
determining objects that appear in the one or more extracted images using, at least in part, the one or more previously trained machine learning models with the one or more re-trained classification layers.
